(19) United States
(12) Patent Application Publication
(10) Pub. No.: US 2026/0041947 A1
(43) Pub. Date: Feb. 12, 2026

(54) NEW ENERGY VEHICLE-SPECIFIC AUTOMATIC FIRE EXTINGUISHER

(71) Applicant: Chenzhou Lianxiang Planning Co., Ltd, Chenzhou (CN)

(72) Inventors: Yuanlong Huang, Chenzhou (CN); Yi Huang, Chenzhou (CN); Keming Huang, Chenzhou (CN); Kewei Huang, Chenzhou (CN)

(21) Appl. No.: 19/057,180

(22) Filed: Feb. 19, 2025

(30) Foreign Application Priority Data
Aug. 6, 2024 (CN) 2024110705021

(51) Int. Cl. A62C 35/13; A62C 3/07; A62C 3/16; B60L 3/00; H01M 10/46; H01M 50/249; H01M 50/673

(52) U.S. Cl. CPC A62C 35/13; A62C 3/07; A62C 3/16; H01M 10/46; H01M 50/249; H01M 50/673; B60L 3/0046; H01M 2220/20

(57) ABSTRACT

A new energy vehicle-specific automatic fire extinguisher includes an automobile chassis, a lower surface of the automobile chassis is mounted with a mounting box, in the mounting box is provided with an on-board battery and a charger; an upper surface of the automobile chassis is provided with a tin-bismuth alloy plate, an upper surface of the tin-bismuth alloy plate is provided with a fire extinguisher bottle, at an outlet end of the fire extinguisher bottle is provided with a tin-bismuth alloy cap, the automobile chassis is provided with a through-hole and the through-hole penetrates through the automobile chassis body and a top box of the mounting box in turn, and the outlet end of the fire extinguisher bottle is provided correspondingly with the through-hole. The device is capable of automatically starting the fire extinguisher when the temperature of the battery rises abnormally, without external power supply or control signal.

### TECHNICAL FIELD

The invention belongs to the technical field of new energy vehicle fire extinguishers, specifically relates to a new energy vehicle-specific automatic fire extinguisher.

### BACKGROUND ART

With the increasing global emphasis on environmental protection and sustainable development, electric vehicles are gradually becoming an important part of modern transportation due to their advantages of zero emissions, low noise and low maintenance costs. However, the widespread popularity of electric vehicles has also brought about a series of new safety challenges. Among them, the most significant safety hazards come from the on-board batteries and chargers of electric vehicles;

On-board batteries, especially lithium-ion batteries, have the advantages of high energy density and long life, but they also have the risk of thermal runaway. Under abnormal conditions such as overcharging, over-discharging, high temperature or physical damage, safety problems such as short circuit and thermal runaway may occur inside the battery, which may lead to fire. In addition, the charger of an electric vehicle may also generate high temperatures, electric arcs, or electric sparks under prolonged operation, overloading, or electrical faults, which may lead to fires;

Therefore, the development of a fire extinguishing device that can be automatically triggered and quickly extinguish the fire source when a fire occurs in an on-board battery or charger is essential for improving the safety of electric vehicles.

### SUMMARY OF THE INVENTION

The technical problem to be solved by the present invention is to overcome the defects of the above technology and provide an automatic fire extinguisher for new energy vehicles. In order to solve the above technical problem, the present invention provides a technical solution for a new energy vehicle-specific automatic fire extinguisher, including an automobile chassis, a lower surface of the automobile chassis is mounted with a mounting box, in the mounting box is provided with an on-board battery and a charger;

an upper surface of the automobile chassis is provided with a tin-bismuth alloy plate, an upper surface of the tin-bismuth alloy plate is provided with a fire extinguisher bottle, at an outlet end of the fire extinguisher bottle is provided with a tin-bismuth alloy cap, the automobile chassis is provided with a through-hole and the through-hole penetrates through the automobile chassis body and a top box of the mounting box in turn, and the outlet end of the fire extinguisher bottle is provided correspondingly with the through-hole.

Further, the tin-bismuth alloy plate is adhesively connected to the automobile chassis.

Further, the fire extinguisher bottle is adhesively connected to the tin-bismuth alloy plate, and the outlet end of the fire extinguisher bottle is adhesively connected to the tin-bismuth alloy cap.

Further, the tin-bismuth alloy plate has a thickness of 2 mm.

Further, the tin-bismuth alloy cap has a thickness of 2 mm.

Compared with the prior art, the invention has the following advantages:
1) the device is capable of automatically starting the fire extinguisher when the temperature of the battery rises abnormally, without external power supply or control signal, and responding rapidly through the melting point characteristics of the tin-bismuth alloy plate and the tin-bismuth alloy cap;
(2) by the way of adhesive connection between the fire extinguisher bottle and the tin-bismuth alloy plate, it ensures that the fire extinguisher bottle will not fall off during the driving process of the vehicle and improves the reliability of the device;
(3) the device is simple in structure, easy to install, and suitable for various new energy vehicles, with a wide range of application prospects.

### BRIEF DESCRIPTION OF ACCOMPANY DRAWINGS

FIG. 1 is a structural diagram of a new energy vehicle-specific automatic fire extinguisher provided by the invention;

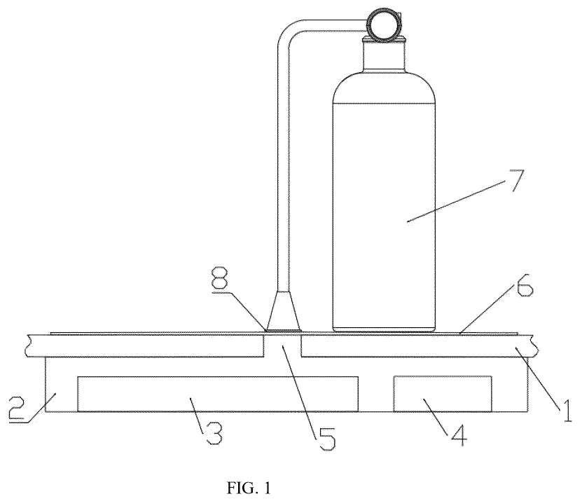

FIG. 2 is a use reference diagram of a new energy vehicle-specific automatic fire extinguisher provided by the invention.

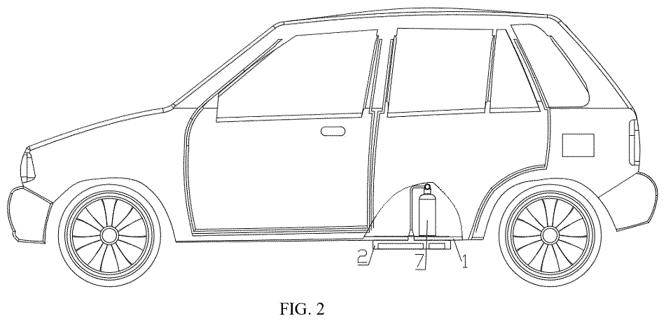

As Shown in the Accompanying Drawings:
1 automobile chassis, 2 mounting box, 3 on-board battery, 4 charger, 5 through-hole, 6 tin-bismuth alloy plate, 7 fire extinguisher bottle, 8 tin-bismuth alloy cap.

### SPECIFIC EMBODIMENT OF THE INVENTION

The invention, a new energy vehicle-specific automatic fire extinguisher is described below with reference to the drawings.

With reference to the drawings, a new energy vehicle-specific automatic fire extinguisher, including an automobile chassis 1, a lower surface of the automobile chassis 1 is mounted with a mounting box 2, in the mounting box 2 is provided with an on-board battery 3 and a charger 4;

an upper surface of the automobile chassis 1 is provided with a tin-bismuth alloy plate 6, an upper surface of the tin-bismuth alloy plate 6 is provided with a fire extinguisher bottle 7, at an outlet end of the fire extinguisher bottle 7 is provided with a tin-bismuth alloy cap 8, the automobile chassis 1 is provided with a through-hole 5 and the through-hole 5 penetrates through the automobile chassis 1 body and a top box of the mounting box 2 in turn, and the outlet end of the fire extinguisher bottle 7 is provided correspondingly with the through-hole 5.

As a preferred solution of the embodiment, the tin-bismuth alloy plate 6 is adhesively connected to the automobile chassis 1 through epoxy adhesive.

As a preferred solution of the embodiment, the fire extinguisher bottle 7 is adhesively connected to the tin-bismuth alloy plate 6 through epoxy adhesive, and the outlet end of the fire extinguisher bottle 7 is adhesively connected to the tin-bismuth alloy cap 8 through epoxy adhesive.

As a preferred solution of the embodiment, the tin-bismuth alloy plate 6 has a thickness of 2 mm.

As a preferred solution of the embodiment, the tin-bismuth alloy cap 8 has a thickness of 2 mm.

As a preferred solution of the embodiment, the fire extinguisher bottle 7 is a sodium phosphate dry powder fire extinguisher.

As a preferred solution of the embodiment, the tin-bismuth alloy plate 6 and the tin-bismuth alloy cap 8 have a mass percentage of 52% tin and a mass percentage of 48% bismuth, the tin-bismuth alloy plate 6 and the tin-bismuth alloy cap 8 have a melting point of 138-170° C.

In a specific implementation of the present invention, the mounting box 2 is fixedly connected to the lower surface of the automobile chassis 1, and there is an on-board battery 3 and a charger 4 inside thereof, and there is a through-hole 5 opened on the automobile chassis 1, and the through-hole 5 passes through the automobile chassis 1 body and the top box of the mounting box 2 in turn;

The tin-bismuth alloy plate 6 is adhesively connected with the automobile chassis 1 through epoxy resin, at the same time, the tin-bismuth alloy plate 6 is provided with a fire extinguisher bottle 7, and the fire extinguisher bottle 7 is a 2 kg sodium phosphate dry powder fire extinguisher, at the same time the outlet end of the fire extinguisher bottle 7 is set up correspondingly to the through-hole 5; when a fire occurs in the on-board battery 3 or the charger 4, when the temperature rises to 138-170° C., the tin-bismuth alloy plate 6 will undergo hot melting, and then the tin-bismuth alloy cap 8 will also undergo hot melting after being heated, which will then cause the fire-extinguishing agent inside the fire extinguisher bottle 7 to be sprayed out, and the fire-extinguishing agent will be sprayed into the mounting box 2 through the through-hole 5, so that the fire-extinguishing agent can be directly directed at the source of the fire;

This device can effectively extinguish a fire at the early stage of a fire in a new energy vehicle, prevent the fire from expanding, and improve the safety of the new energy vehicle; at the same time, this device is easy to install and has a low maintenance cost.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. A new energy vehicle-specific automatic fire extinguisher, including an automobile chassis, a lower surface of the automobile chassis is mounted with a mounting box, in the mounting box is provided with an on-board battery and a charger;
an upper surface of the automobile chassis is provided with a tin-bismuth alloy plate, an upper surface of the tin-bismuth alloy plate is provided with a fire extinguisher bottle, at an outlet end of the fire extinguisher bottle is provided with a tin-bismuth alloy cap, the automobile chassis is provided with a through-hole and the through-hole penetrates through the automobile chassis body and a top box of the mounting box in turn, and the outlet end of the fire extinguisher bottle is provided correspondingly with the through-hole.

2. The new energy vehicle-specific automatic fire extinguisher of claim 1, wherein the tin-bismuth alloy plate is adhesively connected to the automobile chassis.

3. The new energy vehicle-specific automatic fire extinguisher of claim 1, wherein the fire extinguisher bottle is adhesively connected to the tin-bismuth alloy plate, and the outlet end of the fire extinguisher bottle is adhesively connected to the tin-bismuth alloy cap.

4. The new energy vehicle-specific automatic fire extinguisher of claim 1, wherein the tin-bismuth alloy plate has a thickness of 2 mm.

5. The new energy vehicle-specific automatic fire extinguisher of claim 1, wherein the tin-bismuth alloy cap has a thickness of 2 mm.
